(19) United States
(12) Patent Application Publication
(10) Pub. No.: US 2003/0018890 A1
(43) Pub. Date: Jan. 23, 2003

(54) Method of local due diligence for accepting certificates

(76) Inventors: Douglas LaVell Hale, Orem, UT (US); Peter Kendrick Boucher, Orem, UT (US); Mark Gordon Gayman, Orem, UT (US)

Correspondence Address: SAWYER LAW GROUP LLP, P O BOX 51418, PALO ALTO, CA, 94303, US

(21) Appl. No.: 09/912,149

(22) Filed: Jul. 23, 2001

(51) Int. Cl. H04L 9/00

(52) U.S. Cl. 713/156

(57) ABSTRACT

The present invention provides a method for performing local due diligence for accepting certificates. The method creates override certificates which add or modify at least one attribute of a certificate issued by a third party for a remote user, based upon due diligence performed locally. In this manner, finer control than accepting or rejecting a certificate is provided to a local user. The local user can also accept certificates absent a trusted third party. The method thus adds flexibility in the acceptance of certificates in a network.

### FIELD OF THE INVENTION

The present invention relates to security in networks, and more particularly to certificates in networks.

### BACKGROUND OF THE INVENTION

The Public Key Infrastructure (PKI) is well known in the art. PKI depends on trusted third parties to perform some level of due diligence in confirming a user's identity, and then vouching for his identity by issuing a public key certificate to the user. A remote user at a remote system may send the certificate to a local user at a local system as proof of his identity. When the local user receives the certificate, a list of trusted third parties for the local user is checked. If the third party who issued the certificate is on the list, then the certificate is validated, and access to the local system is granted to the remote user. Otherwise, the certificate is rejected, and access to the local system is denied the remote user.

Typically, the assertions of the trusted third parties are taken at face value, while the assertions of third parties who have not been accepted are given no value at all. However, the conventional public key certificate approach is inflexible in that the certificates from the third parties are either accepted or not. The local user cannot further customize the acceptance of these certificates. Also, the local user is unable to accept new certificates absent an assertion by a trusted third party, even when the user knows the new certificate is trustworthy.

Accordingly, there exists a need for a method for performing local due diligence for accepting certificates. The method should provide customization of the acceptance of certificates and allow new certificates to be accepted absent an assertion by a trusted third party. The present invention addresses such a need.

### SUMMARY OF THE INVENTION

The present invention provides a method for performing local due diligence for accepting certificates. The method creates override certificates which add or modify at least one attribute of a certificate issued by a third party for a remote user, based upon due diligence performed locally. In this manner, finer control than accepting or rejecting a certificate is provided to a local user. The local user can also accept certificates absent a trusted third party. The method thus adds flexibility in the acceptance of certificates in a network.

### BRIEF DESCRIPTION OF THE FIGURES

FIG. 1 illustrates a preferred embodiment of a system which utilizes the method for performing local due diligence for accepting certificates in accordance with the present invention.

FIG. 2 is a flowchart illustrating a preferred embodiment of a method for performing local due diligence for accepting certificates in accordance with the present invention.

### DETAILED DESCRIPTION

The present invention provides a method for performing local due diligence for accepting certificates. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

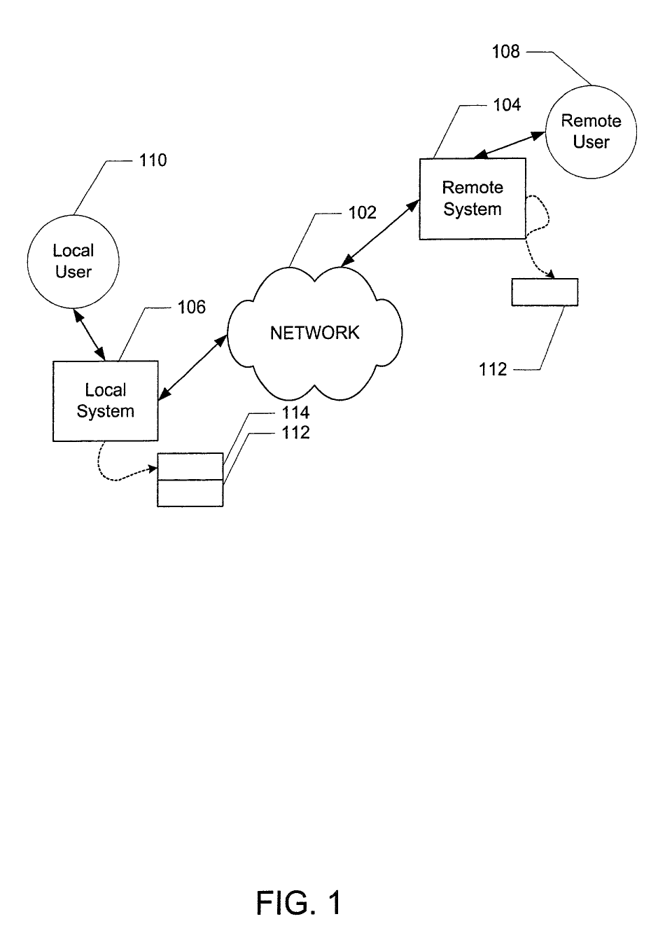

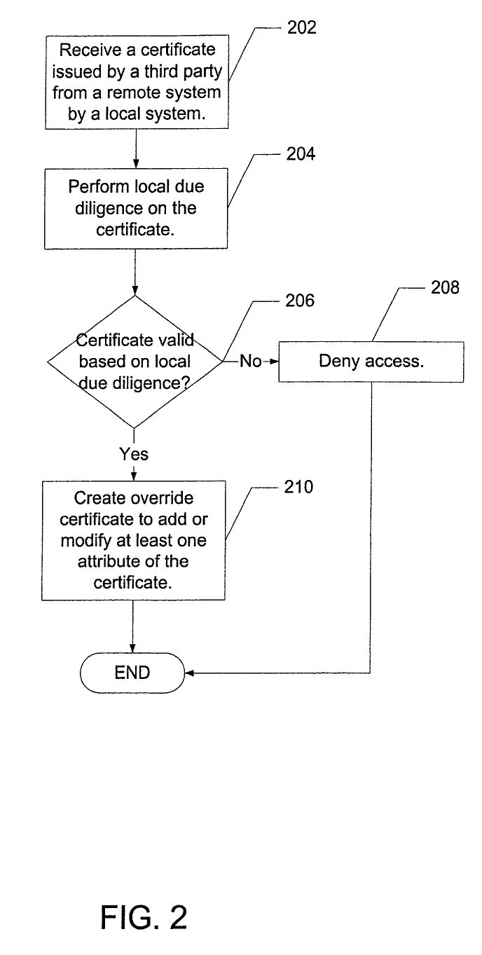

To more particularly describe the features of the present invention, please refer to FIGS. 1 and 2 in conjunction with the discussion below.

FIG. 1 illustrates a preferred embodiment of a system which utilizes the method for performing local due diligence for accepting certificates in accordance with the present invention. The system includes a remote system 104 and a local system 106, both connected via a Public Key Infrastructure (PKI) network 102. A remote user 108 is connected to the network 102 at the remote system 104. A local user 110 is connected to the network at the local system 106. The remote system 104 sends a certificate 112, issued by a third party, to the local system 106. The certificate 112 contains proof of the identity of the remote user 108, as well as a plurality of attributes pertaining to the remote user 108. The local system 106 receives the certificate 112. The local system 106 can modify the certificate 112 by creating an override certificate 114 which corresponds to the certificate 112. The override certificate 114 adds or modifies at least one of the attributes in the certificate 112.

An example attribute which can be added is a trust level from a gradation of trust levels. For example, an Internet commerce site might be trusted enough that the local user 110 is willing to make Cash-On-Delivery orders but not credit card orders. An override certificate 112 with a trust level attribute is created by the local system 106, adding that attribute to the certificate 112. In this manner, the local user 110 doesn't have to only accept or reject the certificate. Varying levels of acceptance can be applied, adding flexibility to the acceptance of certificates.

An example attribute which can be modified is a validity period attribute in the certificate 112. The third party issuing the certificate 112 can place an expiration date of the certificate 112 as an attribute. For example, if the remote user 108 has paid a one year fee to the third party, the third party can include in the certificate a validity period attribute to expire at the end of the one year period. This expiration date can be changed by the creating an override certificate 114 with a different expiration date in the validity period attribute. If the certificate 112 has no validity period attribute, the override certificate 114 can add this attribute.

Another example attribute which can be modified is changing a name attribute in the certificate 112. For example, the name attribute of “Frederick” in the certificate 112 can be changed to “Freddy” in the override certificate 114 if Freddy is a friend of the local user 110. Other attributes can be added or modified without departing from the spirit and scope of the present invention.

FIG. 2 is a flowchart illustrating a preferred embodiment of a method for performing local due diligence for accepting certificates in accordance with the present invention. First, a certificate 112 is received from a remote system 104 by a local system 106, via step 202. The local system 104 then performs local due diligence on the certificate 112, via step 204. The local user 110 defines what local due diligence is conducted. For example, the local user 110 can define it to include determining whether there were prior problems with remote users with certificates issued by the trusted third party; whether the due diligence performed by particular third parties are of a lesser or greater quality than desired; whether the remote user 108 has a certain characteristic, such as being employed by a particular company; and whether the remote user 108 is already known to the local user 110. The local user 110 may choose to perform the local due diligence instead of only trusting the due diligence performed by the trusted third party who issued the certificate 112. The local user 110 may also choose to perform the local due diligence as including the due diligence performed by the trusted third party.

The local system 104 determines if the certificate 112 is valid based on the local due diligence performed, via step 204. If the certificate 112 is not valid, via step 206, then access by the remote user 108 to the local system 106 is denied, via step 208. If the certificate 112 is valid, via step 206, then the local system 106 can create an override certificate 114 which adds or modifies at least one attribute in the certificate 112, via step 210. Access to the local system 106 is then granted to the remote user 108 according to the new set of attributes.

In the preferred embodiment, the override certificate 114 is an extension of the certificate 112. However, the override certificate 114 can replace the certificate 112 instead. The override certificate 114 can also override or replace previously created override certificates. Optionally, an override certificate can be reserved for local use only, or given out to remote users. For example, an override certificate 114 shortening the expiration date the remote user's certificate 112 would be kept on the local system, while an override certificate 114 adding certain access rights attributes to the remote user's certificate 112 could be given out to be kept by the remote system 104.

In a first example, assume that the remote system 104 sends the local system 106 a certificate 112 issued by a trusted third party, via step 202. However, in performing the local due diligence, via step 204, the local system 106 determines that because of past problems with remote users with certificates from this trusted third party, the local user 110 has limited trust in the assertions of the third party. The local user 110 is willing to allow remote users with certificates from this third party to perform certain functions at the local system 106 but not others. For example, the local user 110 may be willing to allow the remote user 108 to read data on the local system 106 but not modify them. The local system 106 determines that the certificate 112 is valid based on the local due diligence performed, via step 206. But the local system 106 creates an override certificate 114 which adds a trust level attribute to the certificate 112, via step 210, such that the remote user 108 is allowed to read data on the local system 106 but not modify them.

In a second example, assume that the local user 110 is familiar with the remote users who work for a particular company and is willing to allow these remote users to have access to the local system 110 for a two year period. The local system 106 receives from the remote system 104 a certificate 112 issued by a trusted third party to the remote user 108, via step 202. The validity period attribute in the certificate 112 indicates that the certificate 112 expires in one year. In performing local due diligence, via step 204, the local system 106 determines that the remote user 108 works for the particular company. The local system 106 thus validates the certificate 112 based on this local due diligence, via step 206. The local system 106 then creates an override certificate 114 which modifies the validity period attribute in the certificate 112 to extend it an additional year, via step 210.

In a third example, assume that the local user 110 personally knows the remote user 108 and trusts the remote user 108. The local user 110 is willing to grant the remote user 108 access to the local system 106 regardless of the remote user's certificate. The local system 106 receives from the remote system 104 a certificate 112 issued by a third party, who is not a trusted third party, to the remote user 108. In performing local due diligence, via step 204, the local system 106 determines that the remote user 108 is a trusted acquaintance, and the local user 110 is willing to grant him access to the local system 106 despite the remote user's certificate from a third party who is not a trusted third party. The local system 106 validates the certificate 112 based on this local due diligence, via step 206. The local system 106 then creates an override certificate 114 which adds an attribute overriding the rejection of the certificate 112. The remote user 108 is then granted access to the local system 106.

A method for performing local due diligence for accepting certificates has been disclosed. The method creates override certificates which add or modify at least one attribute of a certificate issued by a third party for a remote user, based upon due diligence performed locally. In this manner, finer control than accepting or rejecting a certificate is provided to a local user. The local user can also accept certificates absent a trusted third party. The method thus adds flexibility in the acceptance of certificates in a network.

Although the present invention has been described in accordance with the embodiments shown, one of ordinary skill in the art will readily recognize that there could be variations to the embodiments and those variations would be within the spirit and scope the present invention. Accordingly, many modifications may be made by one of ordinary skill in the art without departing from the spirit and scope of the appended claims.

What is claimed is:

1. A method for accepting certificates in a network, the network including a remote system and a local system, comprising the steps of:
(a) receiving a certificate issued by a third party from a remote system by a local system, wherein the certificates comprises at least one attribute;
(b) performing local due diligence at the local system on the certificate;
(c) determining if the certificate is valid based on the local due diligence; and
(d) creating an override certificate to add or modify at least one attribute of the certificate, if the certificate is determined to be valid.

2. The method of claim 1, wherein the certificate contains an identity of a remote user at the remote system.

3. The method of claim 1, wherein the performing step (b) further comprises:
(b1) determining if the third party is a trusted third party.

4. The method of claim 1, wherein the local due diligence is defined by a local user at the local system.

5. The method of claim 1, wherein the determining step (c) comprises:
(c1) determining if the certificate is valid based on the local due diligence instead of relying on a due diligence performed by the third party.

6. The method of claim 1, wherein the determining step (c) comprises:
(c1) determining if the certificate is valid based on the local due diligence and a due diligence performed by the third party.

7. The method of claim 1, wherein the at least one attribute comprises a trust level from a gradation of trust levels.

8. The method of claim 1, wherein the override certificate is an extension of the certificate issued by the third party.

9. The method of claim 1, wherein the override certificate replaces the certificate issued by the third party.

10. The method of claim 1, wherein the override certificate replaces a previously created override certificate.

11. The method of claim 1, further comprising:
(e) granting access to the local system to a remote user at the remote system according to attributes in the override certificate.

12. The method of claim 1, further comprising:
(f) denying access to the local system if the certificate is determined to be invalid.

13. A system, comprising:
a remote system connected to a network;
a local system connected to the network, wherein the local system comprises:
a certificate issued by a third party and received from the remote system, and
an override certificate, wherein the override certificate adds or modifies at least one attribute of the certificate based on local due diligence performed at the local system.

14. The system of claim 13, wherein the override certificate adds or modifies the at least one attribute of the certificate based on the local due diligence performed at the local system instead of relying on due diligence performed by the third party.

15. The system of claim 13, wherein the override certificate adds or modifies the at least one attribute of the certificate based on the local due diligence performed at the local system and a due diligence performed by the third party.

16. The system of claim 13, wherein the override certificate is an extension of the certificate issued by the third party.

17. The system of claim 13, wherein the override certificate replaces the certificate issued by the third party.

18. The system of claim 13, wherein the override certificate replaces a previously created override certificate.

19. The system of claim 13, further comprising:
a remote user at the remote system, wherein the remote user is granted access to the local system according to attributes in the override certificate.

20. A computer readable medium with program instructions for accepting certificates in a network, the network including a remote system and a local system, comprising the instructions for:
(a) receiving a certificate issued by a third party from a remote system by a local system, wherein the certificates comprises at least one attribute;
(b) performing local due diligence at the local system on the certificate;
(c) determining if the certificate is valid based on the local due diligence; and
(d) creating an override certificate to add or modify at least one attribute of the certificate, if the certificate is determined to be valid.

21. The medium of claim 20, wherein the certificate contains an identity of a remote user at the remote system.

22. The medium of claim 20, wherein the performing instruction (b) further comprises instructions for:
(b1) determining if the third party is a trusted third party.

23. The medium of claim 20, wherein the local due diligence is defined by a local user at the local system.

24. The medium of claim 20, wherein the determining instruction (c) comprises instructions for:
(c1) determining if the certificate is valid based on the local due diligence instead of relying on a due diligence performed by the third party.

25. The medium of claim 20, wherein the determining instructions (c) comprises instructions for:
(c1) determining if the certificate is valid based on the local due diligence and a due diligence performed by the third party.

26. The medium of claim 20, wherein the at least one attribute comprises a trust level from a gradation of trust levels.

27. The medium of claim 20, wherein the override certificate is an extension of the certificate issued by the third party.

28. The medium of claim 20, wherein the override certificate replaces the certificate issued by the third party.

29. The medium of claim 20, wherein the override certificate replaces a previously created override certificate.

30. The medium of claim 20, further comprising instructions for:
(e) granting access to the local system to a remote user at the remote system according to attributes in the override certificate.

31. The medium of claim 20, further comprising instructions for:
(f) denying access to the local system if the certificate is determined to be invalid.
